(19) United States
(12) Patent Application Publication
(10) Pub. No.: US 2017/0299724 A1
(43) Pub. Date: Oct. 19, 2017

(54) METHOD FOR ENHANCED STAND-ALONE GLOBAL NAVIGATION SATELLITE SYSTEM (GNSS) PERFORMANCE

(71) Applicant: QUALCOMM Incorporated, San Diego, CA (US)

(72) Inventors: Sheng-Wen HSU, Hsinchu County (TW); Jeremy Robin Christopher O'DONOGHUE, Wokingham (GB)

(21) Appl. No.: 15/099,343

(22) Filed: Apr. 14, 2016

(51) Int. Cl. G01S 19/05; G01S 19/10; G01S 19/08

(52) U.S. Cl. CPC G01S 19/05; G01S 19/08; G01S 19/10

(57) ABSTRACT

The disclosure relates to enhancing performance at a device that implements a stand-alone global navigation satellite system (GNSS) receiver. In particular, a GNSS-enabled mobile device may obtain positioning data from one or more non-satellite sources and determine satellite signal quality in a surrounding environment. As such, in response to determining that the environment surrounding the GNSS-enabled mobile device is a weak satellite signal environment, the GNSS-enabled mobile device may trigger a process to provide the positioning data obtained from the one or more non-satellite sources to the device that implements the stand-alone GNSS receiver such that performance at the device that implements the stand-alone GNSS receiver may be enhanced in poor satellite signal environments.

### TECHNICAL FIELD

The various aspects and embodiments described herein generally relate to enhancing performance at a device that implements a stand-alone global navigation satellite system (GNSS) receiver, and more particularly, to aiding positioning functions at the device that implements the stand-alone GNSS receiver using non-satellite positioning data acquired at an external device.

### BACKGROUND

Mobile communications networks are in the process of offering increasingly sophisticated capabilities associated with the motion and/or position location sensing of a mobile device. New software applications, such as, for example, those related to personal productivity, collaborative communications, social networking, and/or data acquisition, may utilize motion and/or position sensors to provide new features and services to consumers. Moreover, some regulatory requirements of various jurisdictions may require a network operator to report the location of a mobile device when the mobile device places a call to an emergency service, such as a 911 call in the United States. Such motion and/or position determination capabilities have conventionally been provided using digital cellular positioning techniques and/or information acquired from a Global Navigation Satellite System (GNSS). Additionally, with the increasing proliferation of miniaturized motion sensors (e.g., simple switches, accelerometers, angle sensors, etc.), such on-board devices may be used to provide relative position, velocity, acceleration, and/or orientation information.

In conventional digital cellular networks, position location capability can be provided through various time and/or phase measurement techniques. For example, in CDMA networks, one position determination approach used is Advanced Forward Link Trilateration (AFLT). Using AFLT, a mobile device may compute its position from phase measurements of pilot signals transmitted from a plurality of base stations. Improvements to AFLT have been realized by utilizing hybrid position location techniques, where the mobile device may employ a GNSS receiver that can provide position information independent from the information derived from the signals transmitted from the base stations. Moreover, position accuracy can be improved by combining measurements derived from GNSS and AFLT systems using conventional techniques. Furthermore, navigation devices often support popular and increasingly important GNSS wireless technologies, which may include, for example, the Global Positioning System (GPS), GLONASS, Galileo, Beidou, and the Quasi-Zenith Satellite System (QZSS), among others. Location-aware devices supporting GNSS may obtain positioning signals as wireless transmissions received from one or more transmitter-equipped satellites that may be used to estimate geographic position and heading. Some location-aware devices may additionally or alternatively obtain positioning signals as wireless transmissions from terrestrial based transmitters to estimate a geographic position and heading and/or have one or more on-board inertial sensors (e.g., accelerometers, gyroscopes, etc.) to measure an inertial state of the device. Inertial measurements obtained from these on-board inertial sensors may be used in combination with or independent from positioning signals received from satellite and/or terrestrial based transmitters and/or inertial sensors on a vehicle (e.g., accelerometers, gyroscopes, odometers, etc.) to estimate a geographic position and heading.

Although GNSS-based positioning systems are useful, various problems may arise in devices that implement location solutions using a stand-alone GNSS receiver. For example, in location-aware vehicle infotainment systems, most people tend to consider navigation and map applications to be the most important, as users often use the navigation and map applications to find the best path to reach a destination address. In order to do so, the navigation and map applications (and any other location-based applications) depend on a location solution obtaining a current position and heading (e.g., direction) such that the best path can be calculated accordingly. Therefore, a Time to First Fix (TTFF) and the accuracy associated with any location solution typically have the highest priority. In that context, a GNSS receiver is the most common location technology that vehicles use to obtain the current position and direction, whereby the basic concept that a GNSS receiver uses to provide an accurate location and a fast TTFF is to acquire and decode signals from sufficient satellites as fast as possible in order to obtain corresponding time and orbit data (e.g., ephemeris, almanac, etc.).

However, because most vehicle infotainment systems do not have mobile (e.g., cellular) or Wi-Fi network connectivity, most vehicle infotainment systems have location solutions based on a stand-alone GNSS receiver. Accordingly, because the basic principle used in typical stand-alone GNSS positioning algorithms is to have the GNSS receiver acquire as many satellites as possible as fast as possible, the signals broadcasted from the satellites should generally be stable and strong. However, in certain environments, a stand-alone GNSS receiver may be unable to obtain location results in sufficient time or with sufficient accuracy due to no signal, weak signal, and multi-path issues (e.g., in urban areas, indoor parking areas, areas with tall buildings, etc.). In such environments, the GNSS receiver may need more time to acquire satellites, leading to inconvenient and poor user experiences. The navigation application that relies on the GNSS receiver having the ability to acquire satellite signals also may not have the correct location and direction immediately, leading to inaccurate and/or delayed recommended path results that could be worse than the general case.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, techniques used to compute a location solution at a device that uses a stand-alone global navigation satellite system (GNSS) receiver to acquire ephemeris data, an almanac, a reference time, and/or other measurements used to compute the location solution may be augmented or otherwise aided using positioning assistance data supplied from one or more external devices. For example, in various embodiments, the one or more external devices may connect to the device that implements the stand-alone GNSS receiver via any suitable hardware and/or wireless interface (e.g., a USB connection, Wi-Fi carriers, Bluetooth carriers, a Near Field Communication (NFC) interface, etc.). The positioning assistance data supplied from the one or more external devices may therefore be used to reduce a Time to First Fix (TTFF) and enhance accuracy associated with the stand-alone GNSS location solution in various conditions (e.g., environments with no satellite signals or weak satellite signals). Furthermore, in various embodiments, the one or more external devices may periodically update the positioning assistance data provided to the stand-alone GNSS location solution in order to provide the latest aiding measurements or positioning assistance data. For example, in various embodiments, the one or more external devices may determine satellite signal quality in a surrounding environment using a GNSS receiver and trigger the augmentation process in response to detecting no visible satellite signals in the environment and/or that satellite signals visible in the environment are too weak to compute a position fix (e.g., when acquired satellites have an average signal-to-noise ratio (SNR) below a threshold value, the number of visible satellites in the environment is below a threshold value, etc.).

According to various aspects, the one or more external devices may acquire the positioning assistance data from one or more Wi-Fi access points, one or more Bluetooth beacons, one or more cellular base stations, and/or any other suitable non-satellite location data source(s). Furthermore, the one or more external devices may provide dead reckoning results to the stand-alone GNSS location solution in the event that inertial measurements, movement data, and/or other suitable sensor data is available to the one or more external devices. For example, in various embodiments, the one or more external devices used to augment or otherwise aid location data acquisition at the stand-alone GNSS location solution may comprise smartphones and/or other suitable mobile devices that implement strong location technology in order to support location-based services such as navigation, local news, social applications, local advertisements, etc. As such, in various embodiments, the one or more external devices may update position, ephemeris, almanac, and time data from satellites, Wi-Fi access points, GNSS servers, or a mobile cellular network on a regular basis, whereby the one or more external devices may have access to non-satellite positioning data that can be used to augment positioning functions at the stand-alone GNSS solution. Furthermore, many users connect mobile devices to vehicle infotainment systems in order to charge the mobile devices, support hands-free calling, stream audio through vehicle speakers, etc. (e.g., via a USB connection, a Bluetooth connection, a Wi-Fi Direct connection, a Near Field Communication (NFC) connection, etc.). As such, mobile devices may provide an ideal external data source that can be used to provide positioning assistance data that can augment performance associated with positioning functions performed in vehicles and/or other suitable devices that implement a stand-alone GNSS location solution based on the strong location technology available thereon and the simplicity and well-established interfaces used to connect mobile devices.

According to various aspects, a method for enhancing performance at a device that implements a stand-alone GNSS receiver may therefore comprise establishing, at a GNSS-enabled mobile device, a communication link with the device that implements the stand-alone GNSS receiver, obtaining, at the GNSS-enabled mobile device, positioning data from one or more non-satellite sources (e.g., a reference time, ephemeris data, an almanac, etc. associated with a satellite positioning system (SPS)), determining, at the GNSS-enabled mobile device, satellite signal quality in an environment surrounding the GNSS-enabled mobile device, and triggering, at the GNSS-enabled mobile device, a process to provide the positioning data obtained from the one or more non-satellite sources to the device that implements the stand-alone GNSS receiver via the communication link in response to determining that the environment surrounding the GNSS-enabled mobile device is a weak satellite signal environment based on the determined satellite signal quality. For example, in various embodiments, the method may comprise detecting, at the GNSS-enabled mobile device, the weak satellite signal environment based on visible satellites in the environment surrounding the GNSS-enabled mobile device failing to meet or exceed a threshold value, based on visible satellites in the environment surrounding the GNSS-enabled mobile device having an average signal-to-noise (SNR) ratio that fails to meet or exceed a threshold value, and/or any suitable combination thereof.

According to various aspects, methods for enhancing performance at a device that implements a stand-alone GNSS receiver may further comprise exchanging, between the GNSS-enabled mobile device and the device that implements the stand-alone GNSS receiver, one or more messages that include encrypted data via the communication link, wherein the process to provide the positioning data obtained from the one or more non-satellite sources to the device that implements the stand-alone GNSS receiver is triggered in response to the GNSS-enabled mobile device and the device that implements the stand-alone GNSS receiver confirming trust based on the encrypted data in the one or more exchanged messages. According to various aspects, the method may comprise starting a timer upon providing the positioning data from the one or more non-satellite sources to the device that implements the stand-alone GNSS receiver and providing updated positioning data obtained from the one or more non-satellite sources to the device that implements the stand-alone GNSS receiver in response to determining that the timer has expired.

According to various aspects, methods for enhancing performance at a device that implements a stand-alone GNSS receiver may further comprise computing, at the GNSS-enabled mobile device, a current position fix based at least in part on the positioning data obtained from the one or more non-satellite sources, wherein the positioning data provided to the device that implements the stand-alone GNSS receiver may comprise the current position fix. Furthermore, according to various aspects, the GNSS-enabled mobile device may apply dead reckoning to advance a prior position fix based at least in part on data obtained from one or more motion sensors, wherein the positioning data provided to the device that implements the stand-alone GNSS receiver may comprise a result from applying the dead reckoning. Furthermore, where the device that implements the stand-alone GNSS receiver obtains satellite-based positioning data subsequent to the GNSS-enabled mobile device providing the positioning data, the method may comprise receiving, at the GNSS-enabled mobile device, the satellite-based positioning data from the device that implements the stand-alone GNSS receiver and verifying accuracy associated with the positioning data obtained from the one or more non-satellite sources based on the satellite-based positioning data received from the device implementing the stand-alone GNSS receiver.

According to various aspects, an apparatus may comprise an external interface configured to establish a communication link with a device that implements a stand-alone GNSS receiver, one or more transceivers configured to obtain positioning data from one or more non-satellite sources, a GNSS receiver configured to search for visible satellite signals, and one or more processors configured to determine satellite signal quality in an environment surrounding the apparatus based on the satellite signals visible to the GNSS receiver and to trigger a process to provide the positioning data obtained from the one or more non-satellite sources to the device that implements the stand-alone GNSS receiver via the established communication link based on the determined satellite signal quality indicating that the environment surrounding the apparatus is a weak satellite signal environment.

According to various aspects, an apparatus may comprise means for establishing a communication link with a device that implements a stand-alone GNSS receiver, means for obtaining positioning data from one or more non-satellite sources, means for determining satellite signal quality in an environment surrounding the apparatus, and means for triggering a process to provide the positioning data obtained from the one or more non-satellite sources to the device that implements the stand-alone GNSS receiver via the communication link based on the determined satellite signal quality indicating that the environment surrounding the apparatus is a weak satellite signal environment.

According to various aspects, a computer-readable storage medium may store computer-executable instructions configured to cause a mobile device to establish a communication link with a device that implements a stand-alone GNSS receiver, obtain positioning data from one or more non-satellite sources, determine satellite signal quality in an environment surrounding the mobile device, and trigger a process to provide the positioning data obtained from the one or more non-satellite sources to the device that implements the stand-alone GNSS receiver via the communication link based on the determined satellite signal quality indicating that the environment surrounding the mobile device is a weak satellite signal environment.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary operating environment in which one or more devices can determine position using wireless techniques, according to various aspects.

FIG. 2 illustrates an exemplary mobile device configured to determine a position using wireless techniques, according to various aspects.

FIG. 3 illustrates an exemplary sensor-assisted positioning unit that can provide positioning assistance data to a device that implements a location solution based on a stand-alone GNSS receiver, according to various aspects.

FIG. 4 illustrates an exemplary handshake protocol that can be used to establish a connection between a device that implements a location solution based on a stand-alone GNSS receiver and an aiding device that can provide positioning assistance data to enhance the stand-alone GNSS performance, according to various aspects.

FIG. 5 illustrates an exemplary method that may be performed at a location-aware device that can provide positioning assistance data to a device that implements a stand-alone GNSS location solution, according to various aspects.

FIG. 6 illustrates an exemplary method that a device that implements a stand-alone GNSS location solution may perform to enhance performance using positioning assistance data provided from an aiding device, according to various aspects.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

The various aspects and embodiments described herein may be used in various wireless communication networks such as a wireless wide area network (WWAN), a wireless local area network (WLAN), a wireless personal area network (WPAN), and so on. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more radio access technologies (RATs) such as CDMA2000, Wideband-CDMA (W-CDMA), and so on. CDMA2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). CDMA2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of a WWAN, WLAN and/or WPAN.

According to various aspects, as described in further detail herein, techniques that a device that uses a stand-alone global navigation satellite system (GNSS) receiver to acquire ephemeris data, an almanac, a reference time, and/or other measurements used to compute a location solution may be augmented or otherwise aided using positioning assistance data supplied from one or more external devices. For example, in various embodiments, the one or more external devices may connect to the device that implements the stand-alone GNSS receiver via any suitable hardware and/or wireless interface (e.g., a USB connection, Wi-Fi carriers, Bluetooth carriers, a Near Field Communication (NFC) interface, etc.). The positioning assistance data supplied from the one or more external devices may therefore be used to reduce a Time to First Fix (TTFF) and enhance accuracy associated with the stand-alone GNSS location solution in various conditions (e.g., environments with no or weak satellite signals). Furthermore, in various embodiments, the one or more external devices may periodically update the positioning assistance data provided to the stand-alone GNSS location solution in order to provide the latest aiding measurements or positioning assistance data. For example, in various embodiments, the one or more external devices may determine satellite signal quality in a surrounding environment using a GNSS receiver and trigger the augmentation process in response to detecting no visible satellite signals in the environment and/or that satellite signals that are visible within the environment are too weak to compute a position fix (e.g., when acquired satellites have an average signal-to-noise ratio (SNR) below a threshold value, the number of visible satellites in the environment is below a threshold value, etc.).

According to various aspects, the one or more external devices may acquire the positioning assistance data from one or more Wi-Fi access points, one or more Bluetooth beacons, one or more cellular base stations, and/or any other suitable non-satellite location data source(s). Furthermore, the one or more external devices may provide dead reckoning results to the stand-alone GNSS location solution in the event that inertial measurements, movement data, and/or other suitable sensor data is available to the one or more external devices. For example, in various embodiments, the one or more external devices used to augment or otherwise aid location data acquisition at the stand-alone GNSS location solution may comprise smartphones and/or other suitable mobile devices that implement strong location technology in order to support location-based services such as navigation, local news, social applications, local advertisements, etc. As such, in various embodiments, the one or more external devices may update position, ephemeris, almanac, and time data from satellites, Wi-Fi access points, GNSS servers, or a mobile cellular network on a regular basis, whereby the one or more external devices may have access to non-satellite positioning data that can be used to augment positioning functions at the stand-alone GNSS solution. Furthermore, many users connect mobile devices to vehicle infotainment systems in order to charge the mobile devices, support hands-free calling, stream audio through vehicle speakers, etc. (e.g., via a USB connection, a Bluetooth connection, a Wi-Fi Direct connection, a Near Field Communication (NFC) connection, etc.). As such, mobile devices may provide an ideal external data source that can be used to provide positioning assistance data that can augment performance associated with positioning functions performed in vehicles and/or other suitable devices that implement a stand-alone GNSS location solution based on the strong location technology available thereon and the simplicity and well-established interfaces used to connect mobile devices.

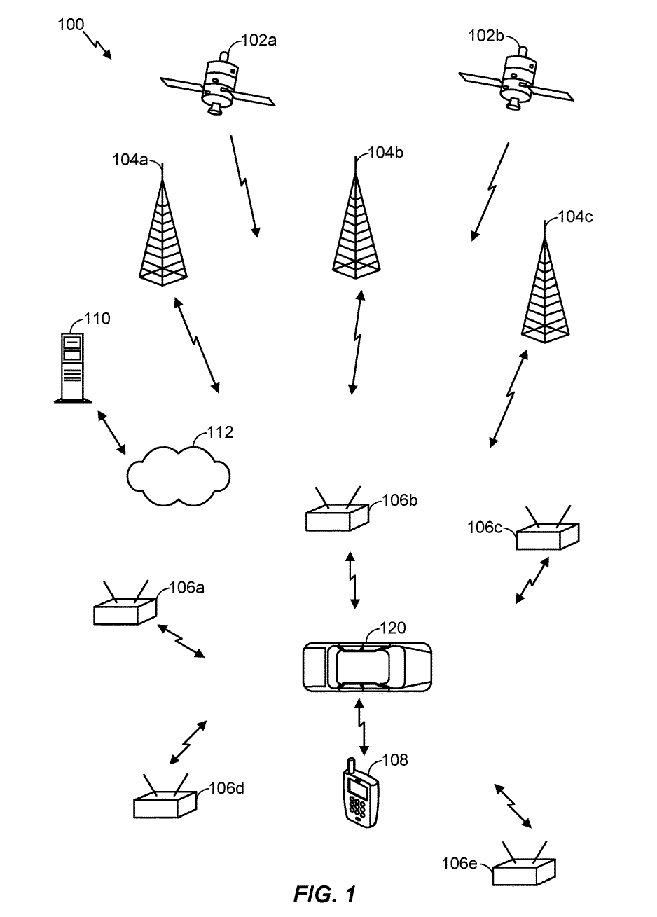

More particularly, referring to FIG. 1, an exemplary operating environment 100 is illustrated in which one or more devices can determine position using wireless techniques, according to various aspects. For example, in various embodiments, the operating environment 100 shown in FIG. 1 includes a mobile device 108 having satellite and non-satellite wireless positioning capabilities in addition to a vehicle 120 that may implement a location solution using a stand-alone GNSS receiver.

In various embodiments, the mobile device 108 may be configured to determine a position associated therewith based upon round trip time (RTT) measurements and/or other measurements that can be adjusted to accommodate processing delays introduced from one or more wireless access points, wherein the processing delays may vary among different wireless access points and may also change over time. For example, in various embodiments, the mobile device 108 may include one or more motion sensors, wherein information from the one or more motion sensors may be used to calibrate out the effects from the processing delays introduced from the one or more wireless access points. In the exemplary operating environment 100 illustrated in FIG. 1, one or more different wireless communication systems and/or wireless positioning systems may be configured to provide positioning data usable at the mobile device 108.

For example, according to various embodiments, the operating environment 100 shown in FIG. 1 includes one or more satellites 102a, 102b, etc. that can provide an independent position information source to the mobile device 108, which may include one or more dedicated GNSS receivers configured to receive signals from the satellites 102a, 102b and derive geographic location information therefrom. In addition, as the vehicle 120 shown in FIG. 1 implements a location solution using a stand-alone GNSS receiver, the one or more satellites 102a, 102b, etc. can likewise provide an independent position information source to the vehicle 120, which may use the stand-alone GNSS receiver implemented thereon to receive signals from the satellites 102a, 102b and derive geographic location information therefrom. In addition, as shown in FIG. 1, the operating environment 100 may further include one or more Local Area Network Wireless Access Points (LAN-WAPs) 106a, 106b, 106c, 106d, 106e, which may be used for wireless voice and/or data communication and provide another independent position information source to the mobile device 108. Furthermore, the operating environment 100 may also include one or more Wide Area Network Wireless Access Points (WAN-WAPs) 104a, 104b, 104c, which may also be used for wireless voice and/or data communication and provide another independent position information source to the mobile device 108. In various embodiments, the WAN-WAPs 104a-104c may form a wireless wide area network (WWAN), which may include cellular base stations at known locations, and/or other wide area wireless systems, such as, for example, Worldwide Interoperability for Microwave Access (WiMAX) (e.g., IEEE 802.16). The WWAN may include other known network components, which are not shown in FIG. 1 for simplicity. Typically, the WAN-WAPs 104a-104c within the WWAN may operate from fixed positions, and provide network coverage over large metropolitan and/or regional areas, while the LAN-WAPs 106a-106e can form a wireless local area network (WLAN) that can operate in buildings and perform communications over smaller geographic regions than a WWAN. Such LAN-WAPs 106a-106e may be part of, for example, Wi-Fi networks (802.11x), cellular piconets and/or femtocells, Bluetooth networks, etc.

In various embodiments, the mobile device 108 may obtain or otherwise derive positioning information from any one or more of the satellites 102a, 102b, the WAN-WAPs 104a-104c, and/or the LAN-WAPs 10a-106e, which may each provide an independent positioning information source that the mobile device 108 can use in position-determining functions using different techniques. Furthermore, in various embodiments, the mobile device 108 may combine the independent positioning information from the satellites 102a, 102b, the WAN-WAPs 104a-104c and/or the LAN-WAPs 106a-106e to improve the accuracy associated with the position-determining functions performed thereon. However, as the vehicle 120 implements a stand-alone GNSS receiver, the independent positioning information available from the WAN-WAPs 104a-104c and the LAN-WAPs 106a -106e is not available to the vehicle 120, which may result in a poor TTFX and inaccuracy in weak signal environments.

According to various embodiments, when deriving position using the satellites 102a, 102b, the mobile device 108 may utilize a GNSS receiver configured to be used to receive signals transmitted from the satellites 102a, 102b and thereby extract position and/or other location-based data using conventional techniques. In addition, the vehicle 120 may likewise use the stand-alone GNSS receiver to receive the signals transmitted from the satellites 102a, 102b and thereby extract position and/or other location-based data using conventional techniques. For example, a global navigation satellite system (GNSS) or satellite positioning system (SPS) typically includes various transmitters positioned to enable an entity to determine a location on or above the Earth based, at least in part, on signals received from the transmitters. Such a transmitter typically transmits a signal marked with a repeating pseudo-random noise (PN) code of a set number of chips and may be located on ground-based control stations, user equipment and/or space vehicles. In a particular example, such transmitters may be located on Earth orbiting satellite vehicles. For example, a satellite vehicle in GNSS constellations such as the Global Positioning System (GPS), Galileo, GLONASS, Beidou, etc. may transmit a signal marked with a PN code distinguishable from PN codes transmitted from other satellite vehicles in the constellation (e.g., using different PN codes for each satellite as in GPS or using the same code on different frequencies as in GLONASS). According to various aspects, the techniques presented herein are not restricted to global systems (e.g., GNSS). For example, the techniques provided herein may be applied to or otherwise enabled for use in various regional systems (e.g., the Quasi-Zenith Satellite System (QZSS) over Japan, Indian Regional Navigational Satellite System (IRNSS) over India, Beidou over China, etc.) and/or various augmentation systems that may be associated with or otherwise enabled for use with one or more global and/or regional navigation satellite systems (e.g., a Satellite Based Augmentation System (SBAS)). For example, an SBAS may include an augmentation system that provides integrity information, differential corrections, etc. such as the Wide Area Augmentation System (WAAS), the European Geostationary Navigation Overlay Service (EGNOS), the Multi-functional Satellite Augmentation System (MSAS), the GPS Aided Geo Augmented Navigation (GAGAN) system, and/or the like. Accordingly, as used herein, the term “GNSS” and variants thereof may refer to any one or more global and/or regional navigation satellite systems and/or augmentation systems, and satellite signals may refer to GNSS, SPS, and/or other satellite positioning signals.

Furthermore, the various aspects described herein may be used with positioning systems that utilize pseudolites and/or positioning systems that utilize satellites in combination with pseudolites. In general, pseudolites are ground-based transmitters that broadcast a PN code or other ranging code (similar to a GPS or CDMA cellular signal) modulated on an L-band (or other frequency) carrier signal, which may be synchronized with GPS time. Each such transmitter may be assigned a unique PN code to permit identification at a remote receiver. Pseudolites are useful in situations where GPS signals from an orbiting satellite might be unavailable, such as in tunnels, mines, buildings, urban canyons, or other enclosed areas. Another implementation of pseudolites is known as radio beacons. As used herein, satellite-based positioning data may therefore be used herein to refer to pseudolites, pseudolite equivalents, and possibly others that the mobile device 108 may acquire from ground-based transmitters.

According to various aspects, when deriving position from the WWAN, the WAN-WAPs 104a-104c may each comprise base stations within a digital cellular network, and the mobile device 108 may include a cellular transceiver and processor that can exploit the base station signals to derive position. Such cellular networks may include, but are not limited to, standards in accordance with GSM, CMDA, 2G, 3G, 4G, LTE, etc. However, those skilled in the art will appreciate that digital cellular networks may include additional base stations or other resources that may not be shown in FIG. 1. Furthermore, while the WAN-WAPs 104a-104c may actually be moveable or otherwise have the ability to be relocated, for illustration purposes the WAN-WAPs 104a-104c will be assumed to essentially be arranged in a fixed position. As such, in various embodiments, the mobile device 108 may perform position determination using known time-of-arrival (TOA) techniques, which may include Advanced Forward Link Trilateration (AFLT) in one example. In other embodiments, each WAN-WAP 104a-104c may comprise a WiMAX wireless networking base station, in which case the mobile device 108 may determine the position associated therewith using TOA techniques from signals provided from the WAN-WAPs 104a-104c. The mobile device 108 may determine positions either in a stand-alone mode, or using the assistance of a positioning server 110 and a network 112 using TOA techniques. Furthermore, in various embodiments, the mobile device 108 may determine position information using WAN-WAPs 104a-104c, which may have different types. For example, some WAN-WAPs 104a-104c may be cellular base stations, and other WAN-WAPs 104a-104c may be WiMAX base stations. In such an operating environment, the mobile device 108 may be able to exploit the signals from each different type of WAN-WAP 104a-104c, and further combine the derived position solutions to improve accuracy.

According to various aspects, when deriving position using the WLAN, the mobile device 108 may utilize TOA techniques with the assistance of the positioning server 110 and the network 112, wherein the positioning server 110 may communicate with the mobile device 108 through the network 112. In various embodiments, the network 112 incorporating the LAN-WAPs 106a-106e may include a wired network, a wireless network, and/or any suitable combination thereof. In various embodiments, each LAN-WAP 106a-106e may be, for example, a Wi-Fi wireless access point, which may not necessarily be set in a fixed position and can change location. The position associated with each LAN-WAP 106a-106e may be stored in the positioning server 110 in a common coordinate system and/or communicated directly from the LAN-WAPs 106a-106e to the mobile device 108. In various embodiments, the mobile device 108 may determine the position associated therewith based on signals received from the LAN-WAPs 106a-106e, wherein each signal may be associated with an originating LAN-WAP 106a-106e based upon some identifying information that may be included in the received signal (e.g., a MAC address). The mobile device 108 may then sort the received signals based upon signal strength and derive the time delays associated with the sorted received signals. The mobile device 108 may then form a message that can include the time delays and the identifying information associated with each LAN-WAP 106a-106e and send the message via network 112 to the positioning server 110. Based upon the received message, the positioning server 110 may then determine a position associated with the mobile device 108 using the stored locations associated with the relevant LAN-WAPs 106a-106e. The positioning server 110 may generate and provide a Location Configuration Indication (LCI) message to the mobile device 108 that includes a pointer to the position of the mobile device 108 in a local coordinate system. The LCI message may also include other points of interest in relation to the location associated with the mobile device 108. When computing the position associated with the mobile device 108, the positioning server 110 may take into account the different delays that different elements within the wireless network may introduce.

According to various aspects, the mobile device 108 may be configured to acquire positioning data from the WAN-WAPs 104a-104c, the LAN-WAPs 106a-106e, pseudolites and/or other ground-based transmitters, a positioning server 110, a network 112, and/or other sources other than and/or in addition to the satellites 102a-102b. However, in certain environments, signals from the satellites 102a-102b may not be visible or may be too weak to compute a location solution independently. In such cases, because the vehicle 120 implements a stand-alone GNSS receiver and can therefore only acquire positioning signals from the satellites 102a, 102b, the mobile device 108 may be configured to trigger an aiding process in order to provide the vehicle 120 with positioning data acquired from the WAN-WAPs 104a-104c, the LAN-WAPs 106a-106e, pseudolites and/or other ground-based transmitters, the positioning server 110, the network 112, and/or other sources other than and/or in addition to the satellites 102a-102b. For example, the mobile device 108 may acquire sufficient information to determine a position, which can be provided to the vehicle 120 to aid in the position-determining functions performed at the vehicle 120. In addition, the other independent positioning information sources may provide the mobile device 108 with ephemeris data that can be used to calculate the position associated with each satellite 102a, 102b, etc., an almanac that provides coarse orbit and status information associated with each satellite 102a, 102b, etc. in a constellation as well as an ionospheric model, and time information to relate time at the satellites 102a, 102b, etc. to Coordinated Universal Time (UTC). Accordingly, in response to the mobile device 108 determining that the operating environment 100 is a weak satellite signal environment (e.g., where the satellites 102a, 102b, etc. are not visible, the visible satellites 102a, 102b, etc. are below a threshold number, the visible satellites 102a, 102b, etc. have an average signal-to-noise ratio (SNR) below a threshold value), the mobile device 108 may trigger an augmentation process to provide any available non-satellite positioning information to the vehicle 120 to enhance performance at the stand-alone GNSS solution implemented thereon.

For example, in addition to providing a current position (if available), the positioning assistance that the mobile device 108 provides may assist the stand-alone GNSS location solution implemented in the vehicle 120 with obtaining the reference time, location, and latest ephemeris data, almanac, etc. such that the searching range associated with the stand-alone GNSS receiver implemented in the vehicle 120 can be reduced and/or a poor TTFF or inaccurate results can be avoided. Furthermore, in various embodiments, the mobile device 108 may be suitably linked to the vehicle 120 through one or more communication interfaces that enable the mobile device 108 to provide the positioning assistance data to the vehicle 120 (e.g., a Bluetooth interface, an RF antenna, a wired connection such as a USB connection, a Wi-Fi Direct connection, a Near Field Communication (NFC) connection, etc.). Furthermore, in various embodiments, the mobile device 108 may have access to one or more inertial sensors and/or other suitable sensor data that can be used to perform dead reckoning in order to advance a prior position fix according to accelerometer, gyroscope, and/or other suitable motion data. Alternatively or additionally, the mobile device 108 may have the ability to receive vehicle odometry and inertial sensor (VOIS) measurements from the vehicle 120 to determine changes in distance traveled, velocity, etc. usable to advance prior position fixes even in weak signal environments. Further still, if the stand-alone GNSS receiver implemented on the vehicle 120 acquires sufficient satellites 102a, 102b, etc. and/or a trusted system time or reference data at some point after the positioning assistance process has been triggered, the location module implemented in the vehicle 120 may verify the positioning assistance data received from the mobile device 108 to ensure that the positioning assistance data is healthy and avoid poor performance in the event that the positioning assistance data received from the mobile device 108 may be inaccurate. Accordingly, the various aspects and embodiments described herein may allow the vehicle 120 that implements a stand-alone GNSS receiver to use valid and healthy position, ephemeris, almanac, time, and/or other suitable positioning data from the mobile device 108 to enhance performance in poor satellite signal environments.

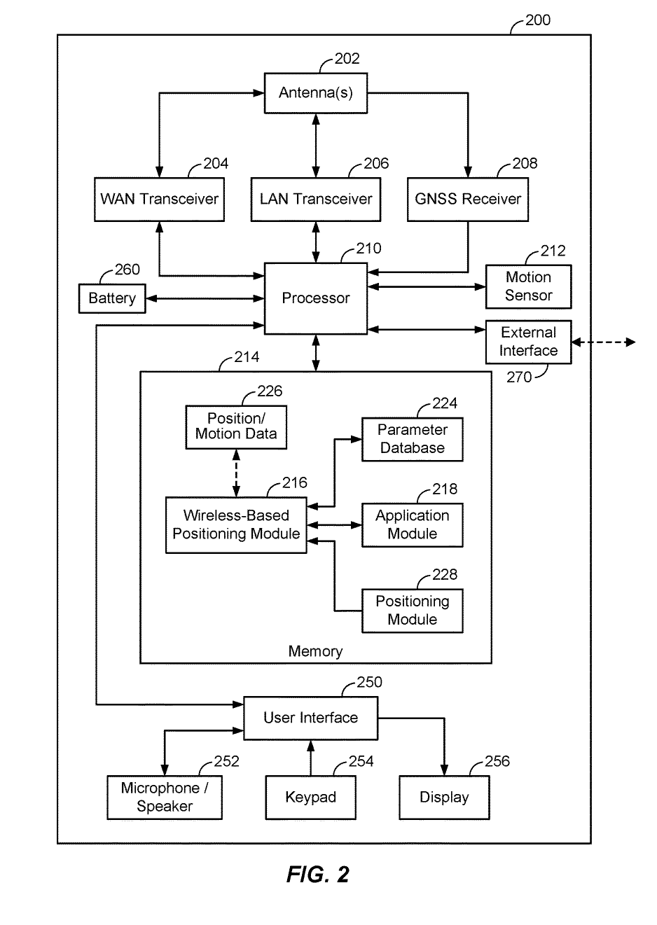

According to various aspects, FIG. 2 illustrates an exemplary mobile device 200 configured to determine a position using wireless techniques. For simplicity, the various features and functions illustrated in FIG. 2 are connected together using a common bus to represent that the various features and functions are operatively coupled together. However, those skilled in the art will recognize that other connections, mechanisms, features, functions, or the like, may be provided and adapted as necessary to operatively couple and configure the mobile device 200. Further, those skilled in the art will appreciate that one or more features and/or functions illustrated in connection with the embodiment shown in FIG. 2 may be further subdivided, two or more features and/or functions illustrated in connection with the embodiment shown in FIG. 2 may be combined, etc. Furthermore, the mobile device 108 shown in FIG. 1 and/or the mobile device 200 as shown in FIG. 2 may be any portable or movable device or machine configurable to acquire wireless signals transmitted from, and transmit wireless signals to, one or more wireless communication devices or networks. As such, the various aspects and embodiments described herein contemplate that the mobile devices 108, 200 may be a radio device, a cellular telephone device, a computing device, a personal communication system (PCS) device, or other like movable wireless communication equipped device, appliance, or machine. The term “mobile device” may also include devices that communicate with a personal navigation device (PND), such as by short-range wireless, infrared, wired connection, or other connection, regardless of whether satellite signal reception, assistance data reception, and/or position-related processing occurs at the device or at the PND. Also, the term “mobile device” is intended to include all devices, including wireless devices, computers, laptops, etc. that can communicate with a server, such as via the Internet, Wi-Fi, or other network, and regardless of whether satellite signal reception, assistance data reception, and/or position-related processing occurs at the device, at a server, at another device associated with the network, and/or any operable combination thereof.

According to various aspects, the mobile device 200 may include one or more wide area network (WAN) transceiver(s) 204 that may be connected to one or more antennas 202. The WAN transceiver 204 may comprise suitable devices, hardware, and/or software for communicating with and/or detecting signals to/from WAN-WAPs 104a-104c, and/or directly with other wireless devices within a network. In one aspect, the WAN transceiver 204 may comprise a CDMA communication system suitable for communicating with a CDMA network of wireless base stations. However, in other aspects, the wireless communication system may comprise another type of cellular telephony network, such as, for example, TDMA or GSM. Additionally, any other type of wide area wireless networking technologies may be used, for example, WiMAX (IEEE 802.16), etc. The mobile device 200 may also include one or more local area network (LAN) transceivers 206 that may be connected to one or more antennas 202. The LAN transceiver 206 comprises suitable devices, hardware, and/or software for communicating with and/or detecting signals to/from LAN-WAPs 106a-106e, and/or directly with other wireless devices within a network. In one aspect, the LAN transceiver 206 may comprise a Wi-Fi (802.11x) communication system suitable for communicating with one or more wireless access points; however in other aspects, the LAN transceiver 206 may comprise another type of local area network, personal area network (e.g., Bluetooth), etc. Additionally, any other type of wireless networking technologies may be used, for example, Ultra-wideband, ZigBee, wireless USB, etc.

As used herein, the abbreviated term “wireless access point” (WAP) may be used to refer to WAN-WAPs 104a-104c and/or LAN-WAPs 106a-106e. Specifically, in the following description, the term “WAP” may be used in connection with embodiments in which the mobile device 200 can exploit signals from various LAN-WAPs 106a-106e, various WAN-WAPs 104a-104c, or any combination thereof. The specific WAP utilized at the mobile device 200 may depend upon the environment. Moreover, the mobile device 200 may dynamically select between the various WAPs in order to arrive at an accurate position solution. In other embodiments, various network elements may operate in a peer-to-peer manner, whereby, for example, the mobile device 200 may be replaced with the WAP, or vice versa. Other peer-to-peer embodiments may include another mobile device acting in place of one or more WAPs.

According to various aspects, a GNSS receiver 208 may also be included in the mobile device 200. The GNSS receiver 208 may be connected to the one or more antennas 202 for receiving satellite signals (e.g., GNSS signals), wherein the GNSS receiver 208 may comprise any suitable hardware and/or software that can receive and process the satellite signals. In various embodiments, a processor 210 may request and receive information and operations as appropriate from the GNSS receiver 208 and/or other systems and perform the calculations necessary to determine the position associated with the mobile device 200 using measurements obtained via any suitable GNSS algorithm. In various embodiments, a motion sensor 212 may be coupled to a processor 210 to provide movement and/or orientation information, which may be independent from motion data derived from signals received at the WAN transceiver 204, the LAN transceiver 206, and/or the GNSS receiver 208. For example, in various embodiments, the motion sensor 212 may utilize an accelerometer (e.g., a MEMS device), a gyroscope, a geomagnetic sensor (e.g., a compass), an altimeter (e.g., a barometric pressure altimeter), and/or any other movement detection sensor. Moreover, in various embodiments, the motion sensor 212 may include various different devices and the motion sensor 212 may be configured to combine outputs from the various different devices to provide motion information. For example, the motion sensor 212 may use a multi-axis accelerometer in combination with orientation sensors to provide the ability to compute positions in 2-D and/or 3-D coordinate systems.

In various embodiments, the processor 210 may be connected to the WAN transceiver 204, LAN transceiver 206, the GNSS receiver 208, and the motion sensor 212. The processor 210 may include one or more microprocessors, microcontrollers, and/or digital signal processors that provide processing functions, as well as other calculation and control functionality. The processor 210 may also include memory 214 to store data and software instructions to execute programmed functionality within the mobile device 200. The memory 214 may be on-board the processor 210 (e.g., within the same IC package) and/or external to the processor 210 and functionally coupled over a data bus. In various embodiments, one or more software modules and data tables may reside in memory 214 and utilized at the processor 210 in order to manage communications and positioning determination functionality. As illustrated in FIG. 2, the memory 214 may include and/or otherwise receive a wireless-based positioning module 216, an application module 218, and a positioning module 228. Those skilled in the art will appreciate, however, that the organization associated with the memory 214 as shown in FIG. 2 is merely exemplary, whereby the functionality associated with the modules and/or data structures may be combined, separated, and/or be structured in different ways in different implementations. Furthermore, in one embodiment, a battery 260 may be coupled to the processor 210, wherein the battery 260 may supply power to the processor 210 and various other modules and components located on the mobile device 200 through appropriate circuitry and/or under control of the processor 210.

In various embodiments, the application module 218 may be a process running on the processor 210, which may request position information from the wireless-based positioning module 216. Applications typically run within an upper layer of the software architectures, and may include Indoor Navigation, Buddy Locator, Shopping and Coupons, Asset Tracking, and Location Aware Service Discovery. The wireless-based positioning module 216 may derive the position associated with the mobile device 200 using information derived from time information measured from signals exchanged with various WAPs. In order to accurately determine position using time-based techniques, reasonable estimates of time delays, introduced based on the processing time associated with each WAP, may be used to calibrate/adjust the time measurements obtained from the signals. As used herein, these time delays are referred to as “processing delays.” As such, in various embodiments, calibration to further refine the processing delays associated with the WAPs may be performed using information obtained from the motion sensor 212. In one embodiment, the motion sensor 212 may directly provide position and/or orientation data to the processor 210, which may be stored in memory 214 in a position/motion data module 226. In other embodiments, the motion sensor 212 may provide data, which should be further processed by processor 210 to derive information to perform the calibration. For example, the motion sensor 212 may provide acceleration and/or orientation data (single or multi-axis) which can be processed using positioning module 228 to derive position data for adjusting the processing delays in the wireless-based positioning module 216.

After calibration, the position may then be output to the application module 218 in response to its aforementioned request. In addition, the wireless-based positioning module 216 may utilize a parameter database 224 for exchanging operational parameters. Such parameters may include the determined processing delays for each WAP, positions associated with the WAPs in a common coordinate frame, various network parameters, initial processing delay estimates, etc. In addition, the parameter database 224 may include one or more maps that include various road segments, wherein the parameter database 224 may associate each road segment with an index or other information to identify the particular road segment, a start position and an end position (e.g., expressed using GPS coordinates or other suitable data), and/or additional information that may be relevant to a navigation context (e.g., a speed limit).

In other embodiments, the additional information may optionally include auxiliary position and/or motion data, which may be determined from other sources besides the motion sensor 212, such as, for example, from GNSS measurements. The auxiliary position data may be intermittent and/or noisy, but may be useful as another source of independent information for estimating the processing delays of the WAPs depending upon the environment in which the mobile device 200 operates. For example, data derived from the GNSS receiver 208 may supplement the position data supplied by the motion sensor 212 (either directly from the position/motion data module 226 or derived by the positioning module 228). In other embodiments, the position data may be combined with data determined through additional networks using non-RTT techniques (e.g., AFLT within a CDMA network). In certain implementations, the motion sensor 212 and/or the GNSS receiver 208 may provide all or part of the auxiliary position/motion data to the position/motion data module 226 without further processing by the processor 210. In some embodiments, the motion sensor 212 and/or the GNSS receiver 208 may provide the auxiliary position/motion data directly to the processor 210 without providing such data to the position/motion data module 226.

In various embodiments, the mobile device 200 may include a user interface 250, which provides any suitable interface systems, such as a microphone/speaker 252, a keypad 254, and a display 256 that allows user interaction with the mobile device 200. The microphone/speaker 252 provides for voice communication services using the WAN transceiver 204 and/or the LAN transceiver 206. The keypad 254 comprises any suitable buttons for user input. The display 256 comprises any suitable display, such as, for example, an LCD display, and may further include a touch screen display for additional user input modes. In addition, the mobile device 200 may include an external interface 270 that can be used to connect the mobile device 200 to another (external) device, such as a vehicle and/or other suitable device that implements a location solution based on a stand-alone GNSS receiver. Accordingly, in various embodiments, the mobile device 200 may communicate with the external device via the external interface 270 to provide positioning assistance data to the external device, optionally receive VOIS measurements from the external device if available, and/or otherwise aid the external device to augment position-determining functions performed thereon.

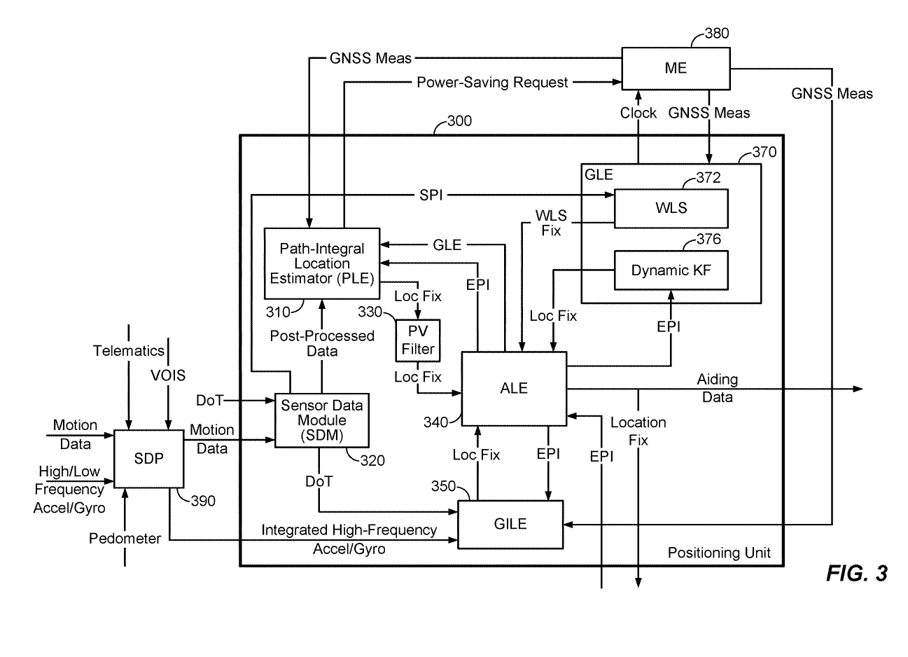

For example, according to various aspects, FIG. 3 illustrates an exemplary sensor-assisted navigation (SAN) system that can be used to provide positioning assistance data to a device that implements a location solution based on a stand-alone GNSS receiver. In particular, as shown in FIG. 3, the SAN system may generally include a positioning unit 300, a measurement engine (ME) 380 that may communicate with the positioning unit 300, and a sensor data processor (SDP) 390 that may further communicate with the positioning unit 300. In one embodiment, the positioning unit 300 may be a composite of several location estimators, which may include a path-integral location estimator (PLE) 310, a sensor data module (SDM) 320, a position velocity (PV) filter 330 (e.g., a cascade filter that may be applied to position, velocity, and/or other location fix outputs from the PLE 310 to further refine and smooth a navigation result), an aggregator location estimator (ALE) 340, a GNSS inertial navigation system (GNSS-INS) location estimator (GILE) 350, and a GNSS location estimator (GLE) 370.

As shown in FIG. 3, the SDP 390 may communicate with the outside world and receive sensor and other data (e.g., telematics sourced from a vehicle). For example, in one embodiment, the SDP 390 may receive VOIS measurements, motion data, high and low frequency accelerometer and gyroscope signals, pedometer signals, telematics data, or other suitable sensor data and provide a “front-end” to the positioning unit 300. Furthermore, the SDP 390 may establish time synchronization between incoming data and GPS time and then assign GPS timestamps to the incoming data, which may comprise direction of travel (DoT) data and motion data that the SDP 390 forwards to the SDM 320 for storage and processing and/or integrated high frequency accelerometer and gyroscope data that the SDP 390 forwards to the GILE 350 for storage and processing. The SDM 320 receives the timestamped data from the SDP 390, computes derived quantities, and buffers and distributes such data inside the positioning unit 300 (e.g., to the GLE 370, the PLE 310, the GILE 350, etc.).

For example, as further shown in FIG. 3, the SDM 320 may distribute post-processed data to the PLE 310, which may use the post-processed data in combination with GNSS measurements received from the ME 380 and GLE 370 and External Position Injection (EPI) data received from the ALE 340 to compute a location fix. The PLE 310 may provide the location fix to the PV filter 330, which may apply the cascade filter mentioned above to refine the location fix computed in the PLE 310 and then provide the refined location fix to the ALE 340. Furthermore, the SDM 320 may provide a Stationary Position Indicator (SPI) to the GLE 370, which may include a weighted least squares (WLS) module 372 that may use the SPI in combination with GNSS measurements received from the ME 380 to compute a WLS fix that may be provided back to the ALE 340 and used to perform a divergence check associated with the location fix computed in the PLE 310 based on the refined location fix received from the PV filter 330. For example, in one embodiment, the divergence check may include the PLE 310 obtaining the WLS fix for a current epoch from the ALE 340 and comparing the WLS fix for the current epoch to the location fix produced therein. As such, in response to detecting a divergence between the WLS fix obtained from the ALE 340 and the location fix produced in the PLE 310, the divergence check may result in resetting the PLE 310 to an uninitialized state. In addition, the GLE 370 may include a dynamic Kalman Filter (KF) 376 that may receive the EPI data from the ALE 340 and compute a location fix that may be used as input to the ALE 340 to support detecting a stationary or non-stationary user and/or to perform a second divergence check. For example, in one embodiment, the second divergence check may compare the location fix received from the PLE 310 (via the PV filter 330) with the location fix received from the dynamic Kalman Filter 376 in the GLE 370 to detect divergence associated with the location fix computed in the PLE 310, wherein if the ALE 340 detects a divergence between the location fix computed in the PLE 310 and the location fix that the dynamic Kalman Filter 376 computed, the ALE 340 may reset the PLE 310 to the location fix computed with the dynamic Kalman Filter 376 in the GLE 370.

In one embodiment, the SAN system may further support dead reckoning techniques to advance a previous location fix (e.g., a previous location fix output from the ALE 340) according to known or estimated velocities and headings using data obtained from inertial sensors (e.g., the DoT, motion data, and integrated high-frequency accelerometer and gyroscope data output from the SDP 390). As such, the dead reckoning techniques may generally advance the previous location fix to calculate a current position and heading that support navigation from the previous location fix, which may reduce a need to acquire a current location fix from the ALE 340 or other components that receive or otherwise acquire GNSS signals because vehicle odometry, modeled vehicle dynamics, or other suitable vehicle parameters that support dead reckoning may be used to advance the previous location fix without having to utilize the ALE 340 or the other components that require GNSS signal measurements while providing the appearance of an always-available position to the user.

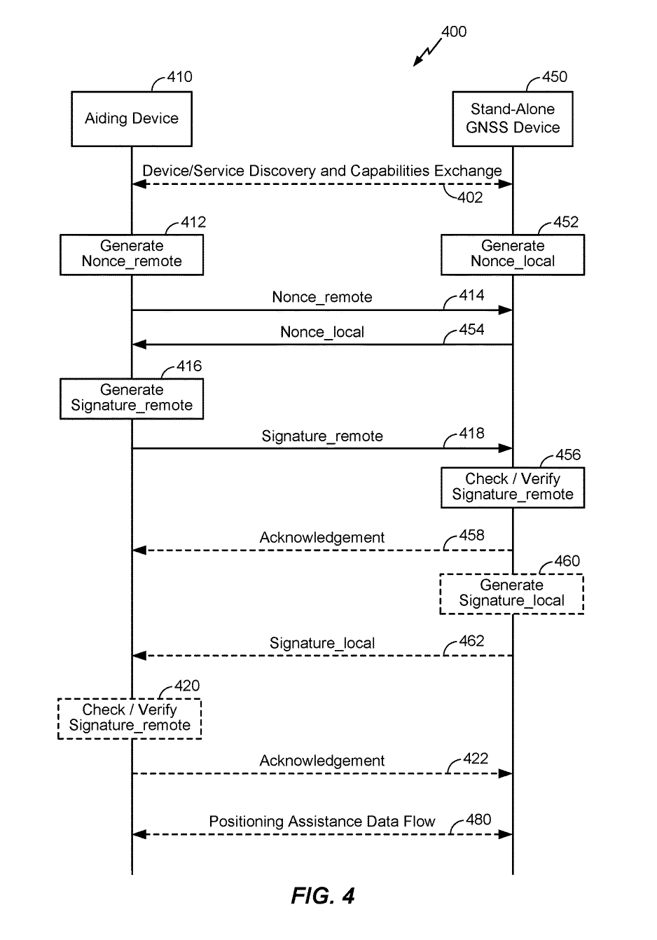

According to various aspects, FIG. 4 illustrates an exemplary handshake protocol 400 that can be used to establish a connection between a device 450 that implements a location solution based on a stand-alone GNSS receiver (hereinafter “stand-alone GNSS device 450”) and an aiding device 410 that can provide positioning assistance data to enhance the stand-alone GNSS performance. More particularly, in various embodiments, the aiding device 410 may be connected to the stand-alone GNSS device 450 via any suitable hardware interface (e.g., a USB connection) and/or wireless interface (e.g., Wi-Fi carriers, Bluetooth carriers, etc.). The aiding device 410 may generally have a GNSS receiver and further have access to one or more non-satellite positioning data sources. As such, the aiding device 410 may initiate the handshake protocol 400 shown in FIG. 4 to establish a connection with the stand-alone GNSS device 450 and thereby enhance the Time to First Fix (TTFF) and accuracy associated with the stand-alone GNSS device 450 in a weak satellite signal environment. For example, the aiding device 410 may initiate the handshake protocol 400 in response to determining that there are no satellite signals visible in a surrounding environment, that acquired satellites visible in the surrounding environment have an average signal-to-noise ratio (SNR) below a threshold value (e.g., 25 dBm), that the number of visible satellites in the surrounding environment is below a threshold value (e.g., 6), or that the surrounding environment otherwise lacks sufficient satellite signals (or sufficiently strong satellite signals) to compute an independent location solution. In such cases, as depicted at 402, the aiding device 410 and the stand-alone GNSS device 450 may initially conduct a device and service discovery and capabilities exchange, which may be based on the Bluetooth Service Discovery Protocol (SDP), Wi-Fi Direct (e.g., Application Service Platform), a Near Field Communication (NFC) Peer to Peer protocol, and/or another suitable protocol. The aiding device 410 and the stand-alone GNSS device 450 may then obtain the Bluetooth, Wi-Fi, NFC, and/or other suitable capabilities (if any) associated with one another and establish a data connection link upon confirming that the mutual capabilities provide the ability to setup the data connection link (e.g., based on the Bluetooth Serial Port Profile (SPP), the Wi-Fi Direct Send Service, the NFC Peer to Peer protocol, etc.).

In various embodiments, as depicted at 412, 452, the aiding device 410 and the stand-alone GNSS device 450 may then each generate a nonce value, which generally refers to a one-time random or pseudo-random number used in the handshake protocol 400. The aiding device 410 and the stand-alone GNSS device 450 may then exchange the respective nonce values, as depicted at 414, 454. The aiding device 410 can then generate a signature (signature_remote) based on the nonce value received from the stand-alone GNSS device 450 according to any suitable encryption method(s), as depicted at 416, and the signature generated at the aiding device 410 may be transmitted to the stand-alone GNSS device 450, as depicted at 418. In various embodiments, as depicted at 456, the stand-alone GNSS device 450 may then compute the expected signature based on the nonce value that was previously sent to the aiding device at 454. In various embodiments, at 458, the stand-alone GNSS device 450 may acknowledge or otherwise authenticate the aiding device 410 in response to verifying that the signature received at 418 matches the expected signature computed at 456. Furthermore, in various embodiments, the stand-alone GNSS device 450 may generate a local signature (signature_local) based on the nonce value received from the aiding device 410 according to any suitable encryption method(s), as depicted at 460, and the local signature may be transmitted to the aiding device 410, as depicted at 462. In various embodiments, as depicted at 420, the aiding device 410 may then compute the expected signature based on the nonce value that was previously sent to the stand-alone GNSS device 450 at 414. In various embodiments, at 422, the aiding device 410 may acknowledge or otherwise authenticate the stand-alone GNSS device 450 in response to verifying that the signature received at 462 matches the expected signature computed at 420. In various embodiments, assuming that the aiding device 410 and the stand-alone GNSS device 450 authenticate one another, a positioning assistance data flow may then start at 480, wherein the aiding device 410 may start to inject the latest time, position, ephemeris, almanac, and/or other suitable positioning data via the connection to the stand-alone GNSS device 450, which may be received at a daemon configured to handle the connection on the stand-alone GNSS device 450 and forwarded to the stand-alone GNSS location module on the stand-alone GNSS device 450. Alternatively, in the event that the aiding device 410 and the stand-alone GNSS device 450 are unable to mutually authenticate one another, the handshake protocol 400 may simply be terminated. In this manner, the handshake protocol 400 may prevent an attacker from spoofing the location associated with the stand-alone GNSS device 450 or otherwise cause the stand-alone GNSS device 450 to go somewhere that the user thereof may not want to go. As such, the handshake protocol 400 can ensure that the stand-alone GNSS device 450 is talking to the aiding device 410, which may be a trusted device, and not to some third-party device.

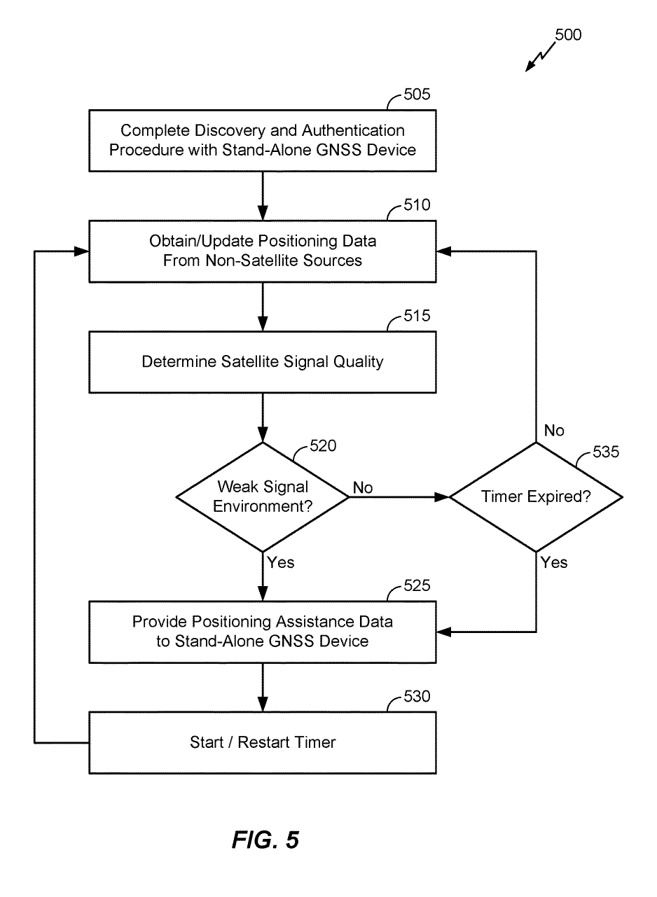

According to various aspects, FIG. 5 illustrates an exemplary method 500 that may be performed at a location-aware device that can provide positioning assistance data to a device that implements a stand-alone GNSS location solution. In particular, at block 505, the location-aware device may perform a discovery and authentication procedure with the device that implements the stand-alone GNSS location solution, which may comprise the handshake protocol 400 described in further detail above with respect to FIG. 4. For example, in various embodiments, the discovery and authentication procedure may comprise a device and service discovery and capabilities exchange in which the location-aware device and the device that implements the stand-alone GNSS location solution obtain capabilities associated with one another and establish a data connection link upon confirming that the mutual capabilities provide the ability to setup the data connection link. The location-aware device and the device that implements the stand-alone GNSS location solution may then exchange respective nonce values and generate local signatures based on the nonce values received from one another, wherein the local signatures may then be exchanged such that the location-aware device and the device that implements the stand-alone GNSS location solution can mutually verify identities associated with one another.

According to various embodiments, assuming that the location-aware device and the device that implements the stand-alone GNSS location solution are able to mutually authenticate one another, the location-aware device may then obtain positioning data from one or more non-satellite sources at block 510. For example, the one or more non-satellite sources may comprise a cellular base station, a Wi-Fi access point, a Bluetooth beacon, and/or any other suitable data source that can provide positioning information to the location-aware device. The location-aware device may therefore be assumed to have obtained at least some positioning data from the one or more non-satellite sources, which may comprise a reference time, ephemeris, almanac, and/or other suitable data associated with a satellite positioning system (SPS). In various embodiments, the positioning data that the location-aware device obtains at block 510 may further comprise a current location or position associated with the location-aware device in the event that the positioning data obtained from the non-satellite source(s) includes enough data to compute a location fix with sufficient accuracy.

According to various embodiments, in addition to including one or more wide area network (e.g., cellular) transceivers, local area network (e.g., Wi-Fi) transceivers, Bluetooth-enabled radios, and/or other suitable interfaces to receive positioning data from the one or more non-satellite sources, the location-aware device may further comprise a GNSS receiver that can be used to search and/or obtain positioning data from a satellite positioning system. As such, at block 515, the location-aware device may use the GNSS receiver to determine satellite signal quality in an environment surrounding the location-aware device, which can be determined based on a number of satellites visible in the surrounding environment, an average signal-to-noise ratio (SNR) associated with satellites that are visible in the surrounding environment, and/or other suitable criteria. Accordingly, at block 520, the location-aware device may determine whether the surrounding environment is a weak satellite signal environment based on the satellite signal quality determined at block 515.

For example, in one use case, the location-aware device may determine that the surrounding environment is a weak satellite signal environment in response to determining that the visible satellites in the surrounding environment are below a threshold value (e.g., six (6) satellites). In another example use case, the location-aware device may determine that the surrounding environment is a weak satellite signal environment in response to determining that the visible satellites in the surrounding environment have an average SNR below a threshold value (e.g., 25 dBm). As such, at block 525, the location-aware device may then trigger a procedure to provide positioning assistance data to the device that implements the stand-alone GNSS location solution in response to detecting a weak satellite signal environment. For example, the location-aware device may start to provide the positioning assistance data to the device that implements the stand-alone GNSS location solution in the event that fewer than six (6) satellites are visible in the surrounding environment (e.g., even though the visible satellites may have an average SNR above the threshold value), in the event that the visible satellites have an average SNR below the threshold value (e.g., even though there may be more than six (6) visible satellites in the surrounding environment), etc.

Alternatively, in response to determining at block 520 that the surrounding environment is not a weak satellite signal environment, the location-aware device may then perform a further check at block 535 to determine whether a timer has expired, wherein the timer may have been started/restarted when positioning assistance data was previously provided to the device that implements the stand-alone GNSS location solution. As such, in various embodiments, the location-aware device may further trigger the procedure to provide positioning assistance data to the device that implements the stand-alone GNSS location solution at block 525 in response to determining that the timer has expired even though the surrounding environment may not be a weak satellite signal environment. Otherwise, in response to determining that the surrounding environment is not a weak satellite signal environment and that the timer that was started/restarted when positioning assistance data was previously provided has not expired, the method 500 may return to block 510 and proceed in substantially the same manner as described above.

According to various embodiments, assuming that the location-aware device determines that the surrounding environment is a weak satellite signal environment and/or that the timer that was started/restarted when the positioning assistance data was previously provided has expired, the location-aware device may then provide available positioning assistance data to the device that implements the stand-alone GNSS location solution at block 525. For example, as mentioned above, the positioning assistance data may comprise time, ephemeris, almanac, and/or other suitable data associated with a satellite positioning system (SPS), wherein providing such positioning data may substantially reduce a searching range used at the stand-alone GNSS receiver and/or provide a faster and more accurate time-to-first-fix (TTFF). Furthermore, in the event that the location-aware device can compute a current position or location fix with sufficient accuracy, the positioning assistance data provided at block 525 may further comprise the current position or location fix computed at the location-aware device. Further still, in various embodiments, the location-aware device may have access to data from one or more on-board inertial sensors, which may comprise an accelerometer, gyroscope, and/or other suitable sensor that can detect motion associated with the location-aware device. Alternatively or additionally, the one or more inertial sensors may be provided on the device that implements the stand-alone GNSS location solution such that the sensor data can be provided to the location-aware device. In either case, assuming that the location-aware device has access to suitable sensor data, whether generated via on-board inertial sensors or received from the device that implements the stand-alone GNSS location solution, the location-aware device may be configured to advance a previous location fix (if available) according to the available sensor data using dead reckoning techniques, whereby the positioning assistance data provided at block 525 may further comprise the dead reckoning results. In various embodiments, the location-aware device may then start/restart the timer at block 530 and return to block 510 such that valid and healthy position, ephemeris, almanac, time, and/or other suitable positioning assistance data can be provided to help the device that implements the stand-alone GNSS location solution with obtaining a position fix and/or enhancing accuracy associated with the GNSS-based location solution in an ongoing manner.

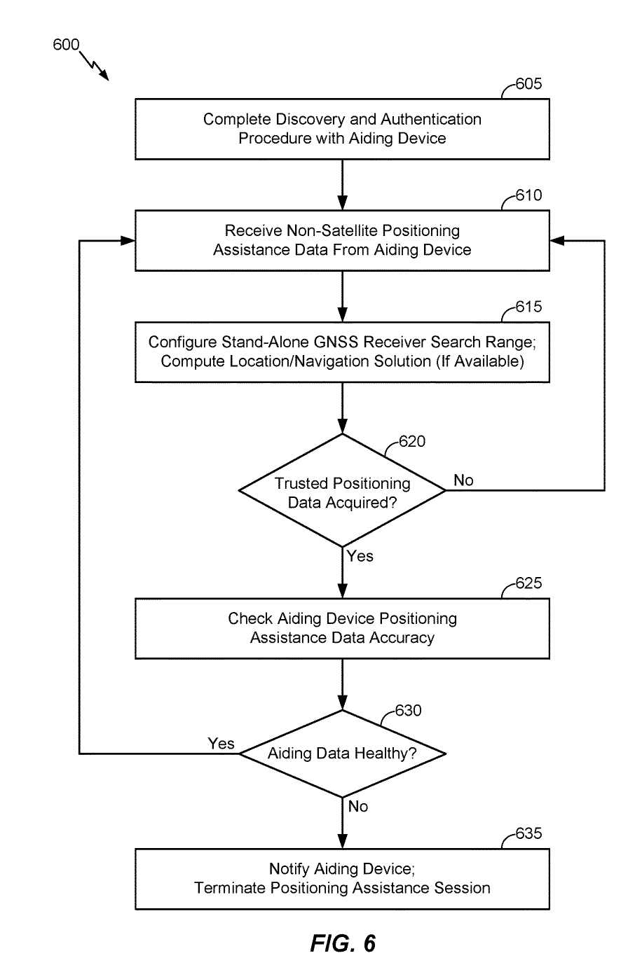

According to various aspects, FIG. 6 illustrates an exemplary method 600 that a device that implements a stand-alone GNSS location solution may perform to enhance performance using positioning assistance data provided from an aiding device. In particular, at block 605, the device that implements the stand-alone GNSS location solution may perform a discovery and authentication procedure with the aiding device, which may comprise the handshake protocol 400 described in further detail above with respect to FIG. 4. For example, in various embodiments, the discovery and authentication procedure performed at block 605 may comprise a device and service discovery and capabilities exchange in which the aiding device and the device that implements the stand-alone GNSS location solution obtain capabilities associated with each another and establish a data connection link upon confirming that mutual capabilities provide the ability to setup the data connection link. The aiding device and the device that implements the stand-alone GNSS location solution may then exchange respective nonce values and generate local signatures based on the nonce values received from one another, wherein the local signatures may then be exchanged such that the aiding device and the device that implements the stand-alone GNSS location solution can mutually verify identities associated with one another.

According to various embodiments, assuming that the aiding device and the device that implements the stand-alone GNSS location solution are able to mutually authenticate one another, the device that implements the stand-alone GNSS location solution may then receive non-satellite positioning assistance data from the aiding device at block 610. For example, in various embodiments, the aiding device may have obtained the positioning assistance data from one or more non-satellite sources, which may comprise a cellular base station, a Wi-Fi access point, a Bluetooth beacon, and/or any other suitable data source from which the aiding device can obtain positioning information. As such, the aiding device may trigger a procedure to provide the non-satellite positioning assistance data based on a surrounding environment being a weak satellite signal environment (e.g., based on satellites visible to the aiding device in the surrounding environment falling below a threshold value, based on satellites visible to the aiding device in the surrounding environment having an average signal-to-noise ratio below a threshold value, etc.). Alternatively or additionally, the non-satellite positioning assistance data may be received from the aiding device at block 610 on a periodic basis, wherein the aiding device may start/restart a timer upon providing the non-satellite positioning assistance data and subsequently update the non-satellite positioning assistance data when the timer expires.

In various embodiments, the non-satellite positioning assistance data received at block 610 may comprise a reference time, ephemeris data, an almanac, and/or other suitable data associated with a satellite positioning system (SPS). Accordingly, at block 615, the device that implements the stand-alone GNSS location solution may configure a search range associated with a stand-alone GNSS receiver based on the positioning assistance data received from the aiding device such that accuracy and a time-to-first-fix (TTFF) can be enhanced at the stand-alone GNSS location solution. Furthermore, in various embodiments, the positioning assistance data received from the aiding device may comprise a current location or position fix computed at the aiding device and/or dead reckoning results computed at the aiding device based on sensor data that may be available to the aiding device. For example, in various embodiments, the aiding device may have one or more on-board inertial sensors that can detect movement to advance a prior position fix. Alternatively or additionally, the device that implements the stand-alone GNSS location solution may include, or have access to, one or more vehicle odometry and inertial sensor (VOIS) measurements that can be provided to the aiding device and used at the aiding device to compute the dead reckoning results. As such, in the event that the received positioning assistance data includes a current location or position fix computed at the aiding device and/or dead reckoning results computed at the aiding device, the device that implements the stand-alone GNSS location solution may further use such information to compute a location/navigation solution.

In various embodiments, at block 620, the device that implements the stand-alone GNSS location solution may then determine whether trusted positioning data has been acquired from one or more satellite sources. For example, the stand-alone GNSS receiver may search for visible satellite signals using the ephemeris data, the almanac, and/or other suitable positioning data that was received from the aiding device. However, should the stand-alone GNSS receiver fail to acquire trusted positioning data from one or more satellite sources (e.g., due to being in a poor satellite signal environment), the method 600 may return to block 610 such that the device that implements the stand-alone GNSS location solution may await updated non-satellite positioning assistance data from the aiding device. On the other hand, in the event that the stand-alone GNSS receiver acquires trusted positioning data from one or more satellite sources, accuracy associated with the positioning assistance data received from the aiding device may then be checked at block 625. In various embodiments, in response to determining at block 630 that the positioning assistance data received from the aiding device is healthy (e.g., where a trusted reference time, ephemeris data, almanac, etc. obtained via the stand-alone GNSS receiver matches the positioning assistance data provided from the aiding device), the method 600 may return to block 610 such that the device that implements the stand-alone GNSS location solution may await updated non-satellite positioning assistance data from the aiding device (e.g., in a next update interval). Alternatively, in response to determining at block 630 that the positioning assistance data received from the aiding device is not healthy (e.g., where the trusted reference time, ephemeris data, almanac, etc. obtained via the stand-alone GNSS receiver differs from the positioning assistance data provided from the aiding device), the aiding device may be notified and the positioning assistance session may be terminated at block 635. Accordingly, the aiding device may be notified to enable the aiding device to obtain the correct positioning data and the positioning assistance session may be terminated to ensure that only valid and healthy position, ephemeris, almanac, time, and/or other positioning assistance data from the aiding device is used at the device that implements the stand-alone GNSS location solution.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the computer-readable medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method for enhancing performance at a device that implements a stand-alone global navigation satellite system (GNSS) receiver, comprising:
establishing, at a GNSS-enabled mobile device, a communication link with the device that implements the stand-alone GNSS receiver;
obtaining, at the GNSS-enabled mobile device, positioning data from one or more non-satellite sources;
determining, at the GNSS-enabled mobile device, satellite signal quality in an environment surrounding the GNSS-enabled mobile device; and
triggering, at the GNSS-enabled mobile device, a process to provide the positioning data obtained from the one or more non-satellite sources to the device that implements the stand-alone GNSS receiver via the communication link in response to determining that the environment surrounding the GNSS-enabled mobile device is a weak satellite signal environment based on the determined satellite signal quality.

2. The method recited in claim 1, further comprising:
detecting, at the GNSS-enabled mobile device, the weak satellite signal environment based on visible satellites in the environment surrounding the GNSS-enabled mobile device failing to meet or exceed a threshold value.

3. The method recited in claim 1, further comprising:
detecting, at the GNSS-enabled mobile device, the weak satellite signal environment based on visible satellites in the environment surrounding the GNSS-enabled mobile device having an average signal-to-noise (SNR) ratio that fails to meet or exceed a threshold value.

4. The method recited in claim 1, further comprising:
exchanging, between the GNSS-enabled mobile device and the device that implements the stand-alone GNSS receiver, one or more messages that include encrypted data via the communication link, wherein the process to provide the positioning data obtained from the one or more non-satellite sources to the device that implements the stand-alone GNSS receiver is triggered in response to the GNSS-enabled mobile device and the device that implements the stand-alone GNSS receiver confirming trust based on the encrypted data in the one or more exchanged messages.

5. The method recited in claim 1, further comprising:
starting a timer upon providing the positioning data from the one or more non-satellite sources to the device that implements the stand-alone GNSS receiver; and
providing updated positioning data obtained from the one or more non-satellite sources to the device that implements the stand-alone GNSS receiver in response to determining that the timer has expired.

6. The method recited in claim 1, wherein the positioning data obtained from the one or more non-satellite sources and provided to the device that implements the stand-alone GNSS receiver comprises one or more of a reference time, ephemeris data, or an almanac associated with a satellite positioning system (SPS).

7. The method recited in claim 1, further comprising:
computing, at the GNSS-enabled mobile device, a current position fix based at least in part on the positioning data obtained from the one or more non-satellite sources, wherein the positioning data provided to the device that implements the stand-alone GNSS receiver comprises the current position fix.

8. The method recited in claim 1, further comprising:
applying, at the GNSS-enabled mobile device, dead reckoning to advance a prior position fix based at least in part on data obtained from one or more motion sensors, wherein the positioning data provided to the device that implements the stand-alone GNSS receiver comprises a result from applying the dead reckoning.

9. The method recited in claim 1, further comprising:
receiving, at the GNSS-enabled mobile device, satellite-based positioning data from the device that implements the stand-alone GNSS receiver, the satellite-based positioning data obtained at the device that implements the stand-alone GNSS receiver subsequent to the GNSS-enabled mobile device providing the positioning data to the device that implements the stand-alone GNSS receiver; and
verifying accuracy associated with the positioning data obtained from the one or more non-satellite sources based on the satellite-based positioning data received from the device that implements the stand-alone GNSS receiver.

10. An apparatus, comprising:
an external interface configured to establish a communication link with a device that implements a stand-alone global navigation satellite system (GNSS) receiver;
one or more transceivers configured to obtain positioning data from one or more non-satellite sources;
a GNSS receiver configured to search for visible satellite signals; and
one or more processors configured to determine satellite signal quality in an environment surrounding the apparatus based on the satellite signals visible to the GNSS receiver and to trigger a process to provide the positioning data obtained from the one or more non-satellite sources to the device that implements the stand-alone GNSS receiver via the established communication link based on the determined satellite signal quality indicating that the environment surrounding the apparatus is a weak satellite signal environment.

11. The apparatus recited in claim 10, wherein the one or more processors are further configured to detect the weak satellite signal environment based on the satellite signals visible to the GNSS receiver failing to meet or exceed a threshold value.

12. The apparatus recited in claim 10, wherein the one or more processors are further configured to detect the weak satellite signal environment based on the satellite signals visible to the GNSS receiver having an average signal-to-noise (SNR) ratio that fails to meet or exceed a threshold value.

13. The apparatus recited in claim 10, wherein the one or more processors are further configured to exchange one or more messages that include encrypted data with the device that implements the stand-alone GNSS receiver via the communication link, wherein the process to provide the positioning data obtained from the one or more non-satellite sources is triggered in response to the apparatus and the device that implements the stand-alone GNSS receiver confirming trust based on the encrypted data in the one or more exchanged messages.

14. The apparatus recited in claim 10, wherein the one or more processors are further configured to:
start a timer upon the positioning data from the one or more non-satellite sources having been provided to the device that implements the stand-alone GNSS receiver; and
provide updated positioning data obtained from the one or more non-satellite sources to the device that implements the stand-alone GNSS receiver in response to the timer expiring.

15. The apparatus recited in claim 10, wherein the positioning data obtained from the one or more non-satellite sources and provided to the device that implements the stand-alone GNSS receiver comprises one or more of a reference time, ephemeris data, or an almanac associated with a satellite positioning system (SPS).

16. The apparatus recited in claim 10, wherein the one or more processors are further configured to compute a current position fix based at least in part on the positioning data obtained from the one or more non-satellite sources, wherein the positioning data provided to the device that implements the stand-alone GNSS receiver comprises the current position fix.

17. The apparatus recited in claim 10, wherein the one or more processors are further configured to apply dead reckoning to advance a prior position fix based at least in part on data obtained from one or more motion sensors, wherein the positioning data provided to the device that implements the stand-alone GNSS receiver comprises a result from the dead reckoning.

18. The apparatus recited in claim 10, wherein the one or more processors are further configured to verify accuracy associated with the positioning data obtained from the one or more non-satellite sources based on satellite-based positioning data received from the device that implements the stand-alone GNSS receiver.

19. An apparatus, comprising:
means for establishing a communication link with a device that implements a stand-alone global navigation satellite system (GNSS) receiver;
means for obtaining positioning data from one or more non-satellite sources;
means for determining satellite signal quality in an environment surrounding the apparatus;
means for triggering a process to provide the positioning data obtained from the one or more non-satellite sources to the device that implements the stand-alone GNSS receiver via the communication link based on the determined satellite signal quality indicating that the environment surrounding the apparatus is a weak satellite signal environment.

20. The apparatus recited in claim 19, further comprising:
means for detecting the weak satellite signal environment based on one or more of visible satellites in the environment surrounding the apparatus failing to meet or exceed a first threshold value or the visible satellites in the environment surrounding the apparatus having an average signal-to-noise (SNR) ratio that fails to meet or exceed a second threshold value.

21. The apparatus recited in claim 19, further comprising:
means for starting a timer upon providing the positioning data from the one or more non-satellite sources to the device that implements the stand-alone GNSS receiver; and
means for providing updated positioning data obtained from the one or more non-satellite sources to the device that implements the stand-alone GNSS receiver in response to determining that the timer has expired.

22. The apparatus recited in claim 19, wherein the positioning data obtained from the one or more non-satellite sources and provided to the device that implements the stand-alone GNSS receiver comprises one or more of a reference time, ephemeris data, or an almanac associated with a satellite positioning system (SPS).

23. The apparatus recited in claim 19, further comprising:
means for computing a current position fix based at least in part on the positioning data obtained from the one or more non-satellite sources, wherein the positioning data provided to the device that implements the stand-alone GNSS receiver comprises the current position fix.

24. The apparatus recited in claim 19, further comprising:
means for applying dead reckoning to advance a prior position fix based at least in part on data obtained from one or more motion sensors, wherein the positioning data provided to the device that implements the stand-alone GNSS receiver comprises a result from applying the dead reckoning.

25. A computer-readable storage medium storing computer-executable instructions, the stored computer-executable instructions configured to cause a mobile device to:
establish a communication link with a device that implements a stand-alone global navigation satellite system (GNSS) receiver;
obtain positioning data from one or more non-satellite sources;
determine satellite signal quality in an environment surrounding the mobile device; and
trigger a process to provide the positioning data obtained from the one or more non-satellite sources to the device that implements the stand-alone GNSS receiver via the communication link based on the determined satellite signal quality indicating that the environment surrounding the mobile device is a weak satellite signal environment.

26. The computer-readable storage medium recited in claim 25, the stored computer-executable instructions further configured to cause the mobile device to:
detect the weak satellite signal environment based on one or more of visible satellites in the environment surrounding the mobile device failing to meet or exceed a first threshold value or the visible satellites in the environment surrounding the mobile device having an average signal-to-noise (SNR) ratio that fails to meet or exceed a second threshold value.

27. The computer-readable storage medium recited in claim 25, the stored computer-executable instructions further configured to cause the mobile device to:
start a timer upon providing the positioning data from the one or more non-satellite sources to the device that implements the stand-alone GNSS receiver; and
provide updated positioning data obtained from the one or more non-satellite sources to the device that implements the stand-alone GNSS receiver in response to determining that the timer has expired.

28. The computer-readable storage medium recited in claim 25, wherein the positioning data obtained from the one or more non-satellite sources and provided to the device that implements the stand-alone GNSS receiver comprises one or more of a reference time, ephemeris data, or an almanac associated with a satellite positioning system (SPS).

29. The computer-readable storage medium recited in claim 25, the stored computer-executable instructions further configured to cause the mobile device to:
compute a current position fix based at least in part on the positioning data obtained from the one or more non-satellite sources, wherein the positioning data provided to the device that implements the stand-alone GNSS receiver comprises the current position fix.

30. The computer-readable storage medium recited in claim 25, the stored computer-executable instructions further configured to cause the mobile device to:
apply dead reckoning to advance a prior position fix based at least in part on data obtained from one or more motion sensors, wherein the positioning data provided to the device that implements the stand-alone GNSS receiver comprises a result from applying the dead reckoning.
